(19) United States
(12) Patent Application Publication
(10) Pub. No.: US 2014/0287629 A1
(43) Pub. Date: Sep. 25, 2014

(54) PLUG-TYPE ELEMENT

(71) Applicant: ERNI Electronics GmbH & Co. KG, Adelberg (DE)

(72) Inventors: Mario Tolj, Ingelfingen (DE); Thomas Engel, Pfedelbach (DE)

(73) Assignee: ERNI ELECTRONICS GMBH & CO. KG, Adelberg (DE)

(21) Appl. No.: 14/345,711

(22) PCT Filed: Sep. 19, 2012
(86) PCT No.: PCT/DE2012/000927

§ 371 Date: Mar. 19, 2014

(30) Foreign Application Priority Data
Sep. 20, 2011 (DE) 10 2011 113 692.8
Nov. 2, 2011 (DE) 10 2011 117 406.4

(51) Int. Cl. H01R 24/20

(52) U.S. Cl. CPC H01R 24/20
USPC 439/682

(57) ABSTRACT

A plug-type element for making contact with a printed circuit board comprises an insulating body. At least one electrical contact which has at least two spring elements is arranged in the insulating body, wherein each spring element has at least one printed circuit board contact (121, 122). In particular, the plug-type element can be a plug-type connector, a relay socket or a safety plug.

The present invention relates to a plug-type element for making contact with a printed circuit board, especially for use in the automotive sector. In particular, the plug-type element can concern a plug connector, a relay socket or a safety socket.

### DESCRIPTION OF THE PRIOR ART

It is necessary to connect various components and also cables to printed circuit boards in modern motor vehicles such as cars, trucks, construction machines, agricultural machines and industrial trucks as well as in helicopters and planes. Plug-type elements which contain female elements are fixed to the printed circuit board for this purpose. Contact can be made with the female elements by components or cable connections with male elements. Such plug-type elements are especially used to mount components such as relays or fuses on the printed circuit board or to connect the printed circuit board to power lines or other printed circuit boards.

Conventional plug-type elements consist of an insulation body in which a connection element is inserted for each potential. This connection element comprises a female element with several flexible tongues, which is arranged in order to securely accommodate a male element of a component and circuit board contacts. They can be fixed by soldering or press-fitting on a printed circuit board.

Conventional plug-type elements show numerous disadvantages when making contact with printed circuit boards in the automotive sector. As a result, the use of a single broad female element for each male element leads to a high need for material in the production of the plug-type elements on the one hand and to difficult producibility of these elements and also an adverse fixing of each knife blade element in the respective female element on the other hand. Furthermore, the use of only one pair of circuit board contacts per male element leads to the consequence that it is impossible to produce a mechanically stable connection to the printed circuit board. Furthermore, corrosion of circuit board contacts can rapidly lead to the consequence that no sufficient connection is ensured any longer between the male element and the printed circuit board.

It is therefore the object of the present invention to provide a plug-type element which overcomes the aforementioned disadvantages of the state of the art.

### SUMMARY OF THE INVENTION

This object is achieved in accordance with the invention by a plug-type element for establishing contact with a printed circuit board, which comprises an insulation body and at least one electrical contact (for a potential) having at least two female elements, wherein each female element comprises at least one circuit board contact. The secure fastening of each male element in the plug-type element is ensured by using several female elements per potential. Furthermore, this produces a redundancy of the female elements, so that even in the case of the failure of one female element or the associated circuit board contact by corrosion for example sufficient contact of the male element with the printed circuit board is still ensured. The ampacity of the plug-type element can further be set by the number of the female elements. In this case, the same female element can be used for plug-type elements with different ampacities, whereas plug-type elements according to the state of the art require different female elements depending on the ampacity. Furthermore, the division of the flowing current to several female elements leads to a reduction in the contact resistance of each contact (current divider).

It is preferable in accordance with the invention that each female element comprises at least two circuit board contacts. Several circuit board contacts per female element produce an additional redundancy for the protection from contact loss between the male element and printed circuit board in case of corrosion of the flexible tongues or circuit board contacts. It is further preferable in accordance with the invention that the widths of the male contact regions of the female elements are substantially the same as the width of the circuit board contacts. It is possible in the plug-type element in accordance with the invention to arrange the male contact regions of the female elements with a width which does not substantially exceed the width of the circuit board contacts, thus leading to a reduction in the required material and the capability to easily produce the female elements. They can be easily produced by punching from a metal plate without subsequent bending of the punched parts.

Is further preferred that each female element comprises two flexible tongues. This is sufficient when using at least two female elements per potential in order to enable sufficient fixing of the male elements. At the same time, simple producibility of the female elements is ensured.

The circuit board contacts are preferably arranged as press-fit elements. The large number of circuit board contacts which can be realized per potential in the plug-type element in accordance with the invention allows producing a sufficiently solid connection when pressing the plug-type element onto a printed circuit board without requiring any further retaining elements for this purpose. It is also possible to solder the plug-type element in accordance with the invention onto a printed circuit board.

The plug-type element in accordance with the invention can concern a plug connector for example. Cables can be connected with such elements to conducting paths of a printed circuit board. The plug-type element in accordance with the invention can also concern a relay socket. It allows fixing a relay to a printed circuit board. In particular, the plug-type element in accordance with the invention concerns a fuse socket. Such fuse sockets are used especially for fuses in the automotive sector. The fuse socket in accordance with the invention preferably comprises two electrical contacts (potentials) which respectively comprise at least two female elements. This ensures secure fastening of the fuse in the fuse socket, so that even in the case of vibrations (e.g. during the travel of a motor vehicle) loosening of the fuse is excluded. In particular, the female elements of the fuse socket are set up in order to accommodate a fuse which is chosen from the group consisting of APS, APM, ATM, APR, ATC, ATO and APX. The configuration of each potential contact in accordance with the invention by the use of several female elements allows producing fuse sockets for fuses of various dimensions as are encompassed by the types of fuses as mentioned above.

An insulation body is preferably arranged between two female elements of an electric contact. An insulation body shall be understood within the terms of the invention as being a material in particular which has an electric conductivity of less than 10⁻⁸ S/m. The electrical insulation of the female elements with respect to each other allows a reduction of the electrical resistance of the contacts in relation to a plug-type element with the female elements which are electrically connected among each other.

In order to ensure a space-saving positioning of the fuse socket in accordance with the invention and to further stabilize said fuse socket from vibrations, it is preferred that the insulation body comprises a first connection element on an exterior side and comprises a second connection element on the opposite exterior side. The first connection element is arranged in such a way that it can be connected in a positive locking manner to the second connection element of an identical installation body. This allows positioning numerous fuse sockets in accordance with the invention in a positive locking manner adjacent to one another, so that they provide each other good stability on the printed circuit board. In an especially preferred way, the insulation body additionally comprises a third connection element on an exterior side and a fourth connection element in the opposite exterior side. This allows an even better mutual stabilization of the fuse sockets.

The plug-type element in accordance with the invention can also concern a distribution circuit board or a power board. A distribution circuit board is understood in accordance with the invention to be a printed circuit board on which female elements are applied by press-fitting for example, wherein the printed circuit board and the female elements are surrounded by an electrically insulating material. The female elements can be arranged in such a way that they are set up for accommodating fuses, relays and/or cables.

### BRIEF DESCRIPTION OF THE DRAWINGS

Embodiments of the invention are shown in the drawings and are explained in the description below in closer detail.

FIG. 1 shows a female element according to an embodiment of the present invention;

FIG. 2 shows a fuse with two male elements according to the state of the art;

FIG. 3 shows an embodiment of a fuse socket according to the invention;

FIG. 4 shows a top view of the fuse socket in accordance with the invention according to FIG. 3;

FIG. 5 shows a fuse socket in accordance with the invention according to FIG. 3 with an inserted fuse according to FIG. 2;

FIG. 6 shows a sectional view through the fuse socket with inserted fuse according to FIG. 5;

FIG. 7 shows three mutually connected fuse sockets according to an embodiment of the invention;

FIG. 8 shows a relay socket with an inserted relay according to an embodiment of the invention;

FIG. 9 shows a top view of the relay socket in accordance with the invention;

FIG. 10 shows a sectional view through the relay socket in accordance with the invention with an inserted relay according to FIG. 8;

FIG. 11 shows a plug connector according to an embodiment of the invention;

FIG. 12 shows a top view of the plug connector in accordance with the invention according to FIG. 11;

FIG. 13 shows a cross-sectional view through the plug socket in accordance with the invention;

FIG. 14 shows a distribution circuit board according to an embodiment of the invention;

FIG. 15 shows a cross-sectional view through the distribution circuit board in accordance with the invention according to FIG. 14;

FIG. 16 shows a detailed sectional view of FIG. 15.

### DETAILED DESCRIPTION OF THE PREFERRED EMBODIMENTS OF THE INVENTION

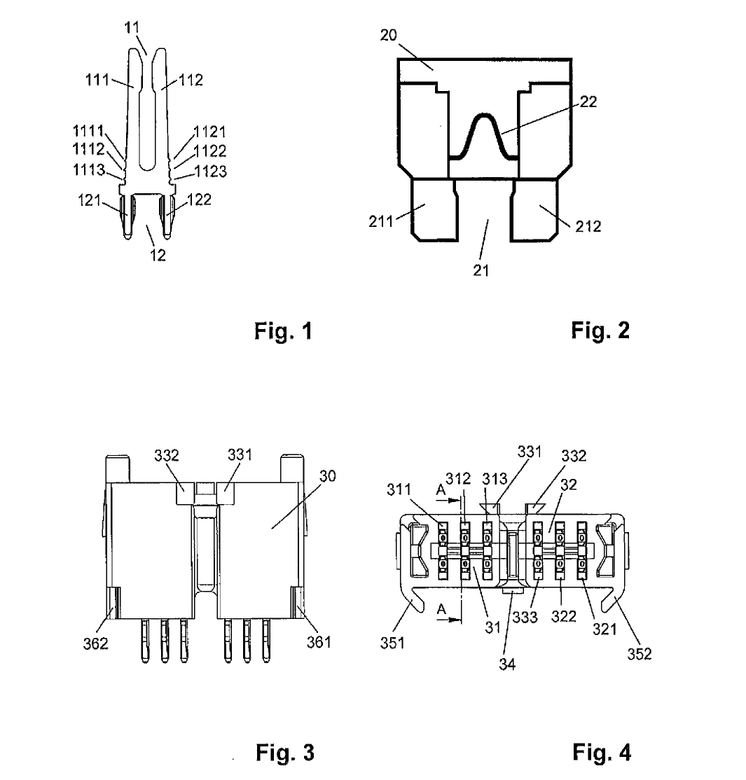

FIG. 1 shows a female element which is used in plug-type elements in accordance with the invention. Said female element 1 comprises a male receiving zone 11, which is provided for accommodating a male element. Said male element receiving zone 11 comprises two flexible tongues 111, 112. Each of the two flexible tongues 111, 112 respectively comprises three connection elements 1111, 1112, 1113, 1121, 1122, 1123 which are arranged as latching hooks. When the female element 1 is introduced into an insulation body, the connection elements 1111, 1112, 1113, 1121, 1122, 1123 prevent that it will be released from the insulation body again. Furthermore, the female element 1 comprises a circuit board contact zone 12. Said circuit board contact zone 12 is preferably arranged as a press-fitting zone. It comprises two circuit board contacts 121, 122.

An embodiment of the invention relates to a fuse socket for accommodating conventional car fuses. Such a car fuse is shown in FIG. 2. The car fuse 2 comprises an insulation body 20 and a contact region 21. Two male elements 211, 212 are arranged in the contact region 21, which reach into the insulation body 20. The two male elements 211, 212 are connected to each other by a fuse element 22 in the installation body 20. It melts when high currents occur and it prevents the connection between the two male elements 211, 212.

A fuse socket 3 in accordance with the invention is shown in FIG. 3. The fuse socket 3 comprises an insulation body 30. FIG. 4 shows a top view of the fuse socket 3 in accordance with the invention. Two electrical contacts 31, 32 are embedded in the insulation body 30. The contact 31 is used in this case for accommodating the male element 211 of the fuse 2 and the contact 32 is used for accommodating the male element 212 of the fuse 2. The contact 31 consists of three female elements 311, 312, 313 which are arranged in parallel, and the contact 32 consists of three female elements 321, 322, 323 which are arranged in parallel. Each of the female elements 311, 312, 313, 321, 322, 323 corresponds to one female element 1 in accordance with the invention. The female elements 311, 312, 313, 321, 322, 323 are respectively electrically insulated from each other by the insulation body 30.

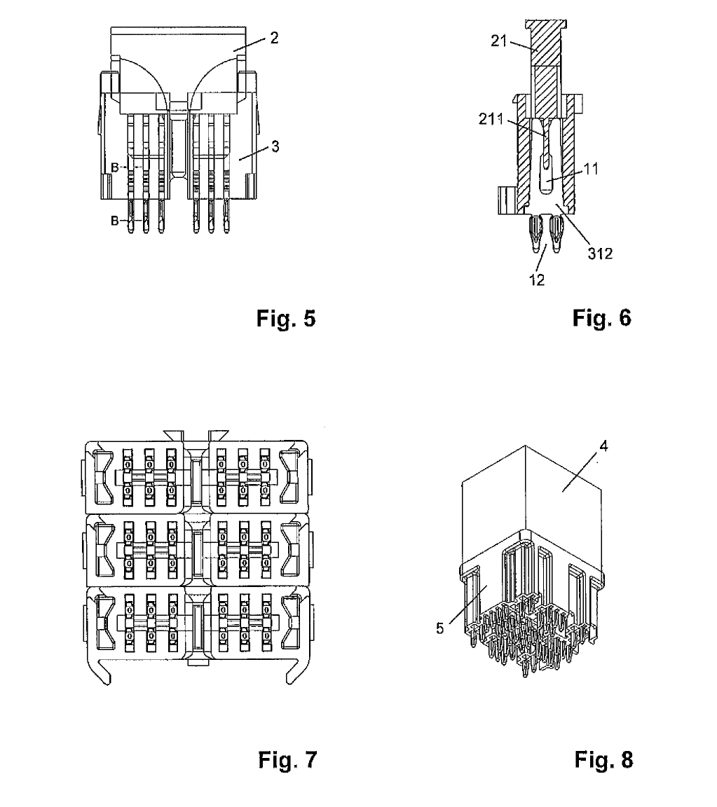

FIG. 5 shows how a fuse 2 can be inserted into the fuse socket 3. The illustration shows in particular that each of the six female elements of the fuse socket 2 has the same width B as the associated circuit board contacts. FIG. 6 shows a sectional view through the fuse socket in accordance with the invention with inserted fuse, as shown in FIG. 5. The section occurs along the line A-A in FIG. 4. The illustration shows that the insulation body 20 of the fuse 2 rests in the insulation body 30 of the fuse socket 3. The male element 211 is held in the intersecting plane according to FIG. 6 by the female element 312. Two circuit board contacts are arranged beneath the male element contact zone of said female element 312.

The fuse socket 3 comprises a first connection element. FIG. 4 shows that said first connection element is arranged in form of two dovetail-shaped elements 331, 332, which are connected to the insulation body 30. Said elements 331, 332 are formed in such a way that they can engage in a second connection element 34 of the fuse socket 3 according to the invention. Said second connection element 34 is arranged as a recess in the insulation body 30 and is situated on the side of the insulation body 30 which is opposite of the first connection element. A third connection element is further situated on the same side of the insulation body 30 as the second connection element 34. It is arranged in form of two bent elements 351, 352, which are respectively connected to the edge of the fuse socket. Said elements 351, 352 are arranged in such a way that they can engage in a fourth connection element of the fuse socket 3. FIG. 3 shows that said fourth connection element is arranged in form of two depressions 361, 362 in the insulation body 30. The openings of these two depressions 361, 362 are situated at the edge of the insulation body 30 on the same side as the insulation body 30 as the connection element. FIG. 7 shows three fuse sockets 3 in accordance with the invention which are connected in a positive locking fashion to each other by means of the connection elements.

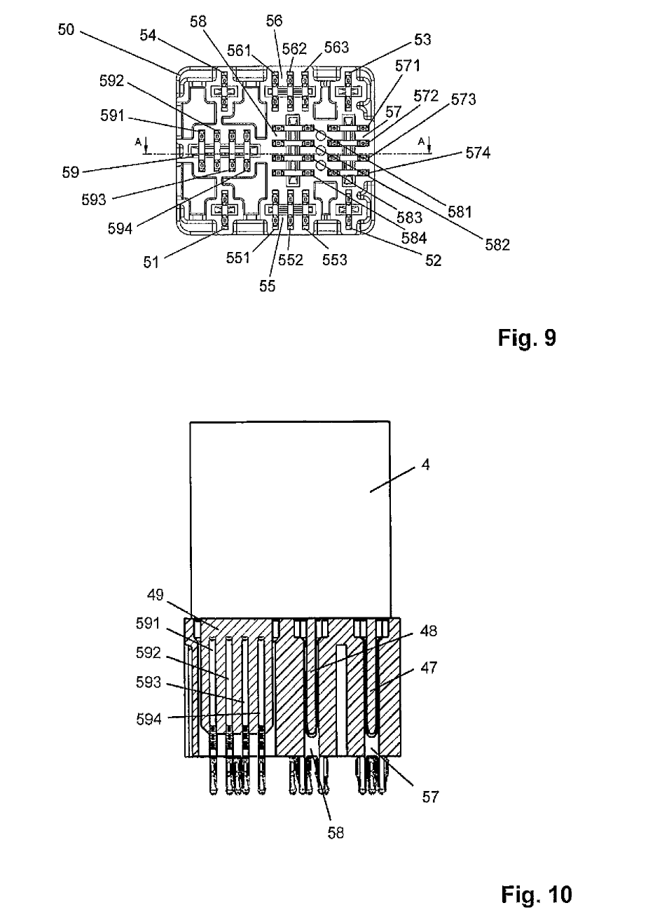

The plug-type element in accordance with the invention is arranged as a relay socket 5 in another embodiment of the present invention. FIG. 8 shows a relay 4 which has been inserted into the relay socket 5 in accordance with the invention. FIG. 9 shows a top view of the relay socket in accordance with the invention. It comprises nine electrical contacts 51, 52, 53, 54, 55, 56, 57, 58, 59 in the insulation body 50. The electrical contacts have a different number of female elements 1. The four contacts 51, 52, 53, 54 each comprise one female element. The two contacts 55 and 56 each comprise three female elements 551, 552, 553, 561, 562, 563. The three contacts 57, 58, 59 each comprise four female elements 571, 572, 573, 574, 581, 582, 583, 584, 591, 592, 593, 594. The female elements 571, 572, 573, 574, 581, 582, 583, 584, 591, 592, 593, 594 are respectively insulated from each other by the insulation body 50. This ensures that contact is made with sufficient holding force and sufficient ampacity with different male elements of the relay 4 which have a different length. FIG. 10 shows a sectional view through the relay socket 5 in accordance with the invention with inserted relay 4 according to FIG. 8 along the line A-A in FIG. 9. The illustration shows how the male elements 47, 48, 49 of the relay 4 engage in associated contact regions 57, 58, 59 of the relay socket. In the plane of intersection, the fixing of the male element 47 occurs by the female element 573, the fixing of the male element 48 by the female element 583, and the fixing of the male element 49, which is twisted by 90° in relation to the male elements 57, 58, by the female elements 591, 592, 593, 594.

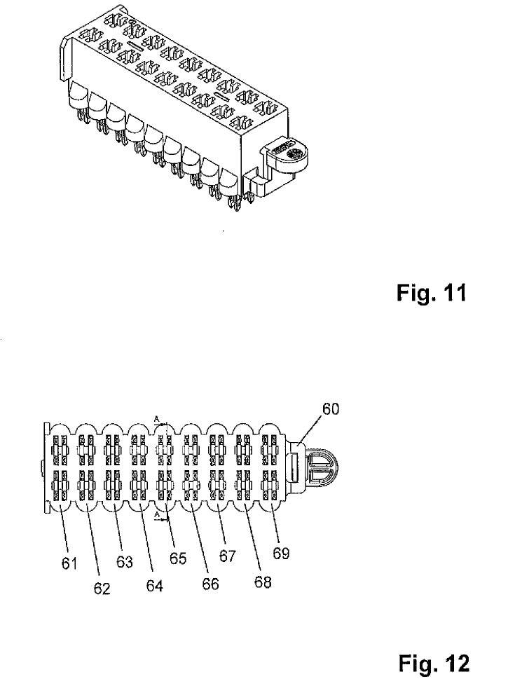

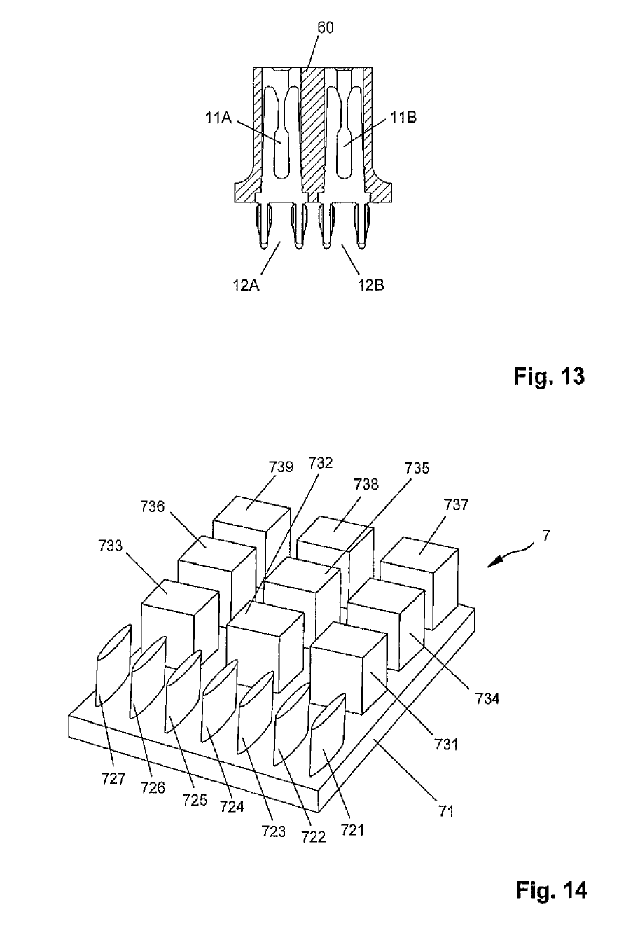

FIG. 11 shows a further embodiment of the plug-type element in accordance with the invention. It concerns a plug connector 6. FIG. 12 shows a top view of the plug connector 6. Nine pairs of contact regions 61, 62, 63, 64, 65, 66, 67, 68, 69 are embedded in the insulation body 60 of the plug connector 6. Each pair of electrical contact regions consists of two female elements 1 in accordance with the invention. The female elements of each pair of contact regions 61, 62, 63, 64, 65, 66, 67, 68, 69 are respectively electrically insulated from each other by the insulation body 60. A sectional view through the plug connector 6 along the line A-A in FIG. 12 is shown in FIG. 13. It shows a pair of female elements 11A, 11 B of the pair of contact regions 65. Each of the female elements 11A, 11 B respectively comprises two circuit board contact elements in its circuit board contact regions 12A, 12B.

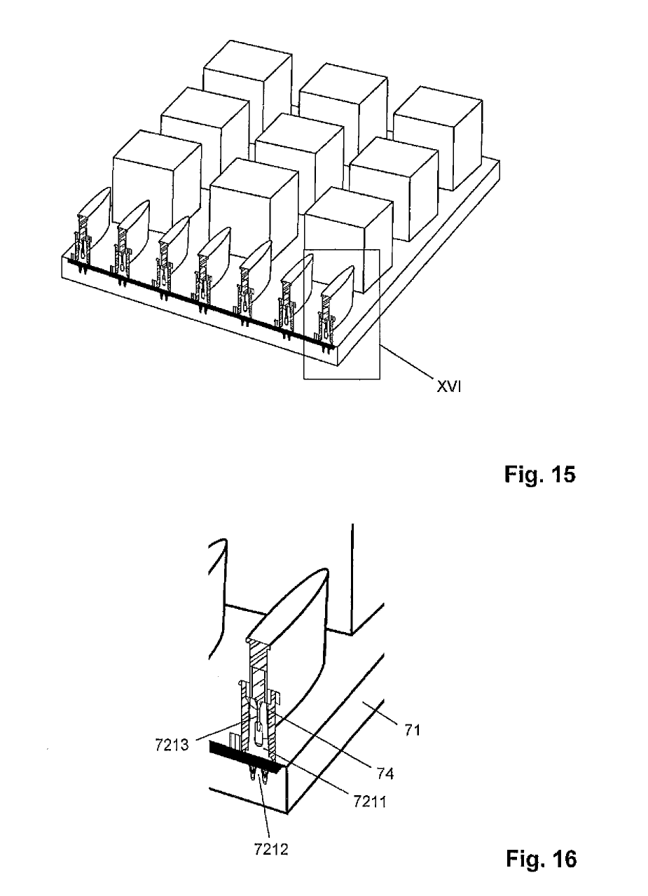

FIG. 14 shows an embodiment of the plug-type element in accordance with the invention. It concerns a distribution circuit board 7. It comprises a printed circuit board 71, seven fuse sockets with inserted fuses 721, 722, 723, 723, 724, 725, 726, 727 and nine relay sockets with inserted relays 731, 732, 733, 734, 735, 736, 737, 738, 739. The printed circuit board 71 as well as the fuse sockets and relay sockets are enclosed by a plastic casing, which can be fastened by latching to the printed circuit board 71. The plastic casing forms an insulation body surrounding the distribution circuit board 7. An isometric cross-sectional drawing of the distribution circuit board 7 is shown in FIG. 15. Each of the fuse sockets of the distribution circuit board 7 comprises three female elements. One respective female element of each fuse socket is shown in the cross-sectional view. FIG. 16 shows the detail which is characterized in FIG. 15 with reference numeral XVI. It shows that a female element 7211 of a fuse socket with inserted fuse 721 is press-fitted into the printed circuit board 71 with circuit board contact elements 7212. It is surrounded by the insulation body 74. A male element 7213 of the fuse is inserted into the female element 7211 and makes contact with the same.

The present invention allows providing a large number various plug-type elements, especially fuse sockets, relay sockets, plug-type connectors and distribution circuit boards, wherein secure gripping of male elements is ensured by using the female elements 1 and the ampacity of the plug-type elements can be set by the number of the female elements 1.

1. A plug-type element for making contact with a printed circuit board, which comprises an insulation body (30, 50, 60), wherein it comprises at least one electrical contact having at least two female elements (1), wherein each female element (1) comprises at least one circuit board contact (121, 122).

2. The plug-type element according to claim 1, wherein each female element (1) comprises at least two circuit board contacts (121, 122), and the width (B) of the male contact region (11) of the female elements is substantially equal to the width of the circuit board contacts (121, 122).

3. The plug-type element according to claim 1, wherein each female element comprises two flexible tongues (111, 112).

4. The plug-type element according to claim 1, wherein the circuit board contacts (121, 122) are arranged as press-fit elements.

5. The plug-type element according to claim 1, wherein the plug-type element concerns a distribution circuit board (7).

6. The plug-type element according to claim 1, wherein the plug-type element concerns a plug connector (6).

7. The plug-type element according to claim 1, wherein the plug-type element concerns a relay socket (5).

8. The plug-type element according to claim 1, wherein the plug-type element concerns a fuse socket (3).

9. The plug-type element according to claim 8, wherein it comprises two receivers (31, 32) for one male element (21, 22)'each, which respectively comprise at least two female elements (311, 312, 313, 321, 322, 323).

10. The plug-type element according to claim 8, wherein the female elements (311, 312, 313, 321, 322, 323) of the fuse socket (3) are set up to accommodate a fuse (2) which is chosen from the group consisting of APS, APM, ATM, APR, ATC, ATO and APX.

11. The plug-type element according to claim 8, wherein the insulation body (30) comprises a first connection element (31) on an exterior side and comprises a second connection element (32) on the opposite exterior side, wherein the first connection element (31) is arranged in such a way that it can be connected in a positive locking fashion to the second connection element (32) of an identical insulation body (30).

12. The plug-type element according to claim 1, wherein an insulation body (30, 50, 60) is arranged between two respective female elements (1) of an electrical contact.
